(19) United States
(12) Patent Application Publication
(10) Pub. No.: US 2025/0260443 A1
(43) Pub. Date: Aug. 14, 2025

(54) Method for positioning a set of reconfigurable intelligent surfaces and associated electronic device

(71) Applicant: ORANGE, ISSY-LES-MOULINEAUX (FR)

(72) Inventors: Youssef Hussein, CHATILLON CEDEX (FR); Thierry Clessienne, CHATILLON CEDEX (FR)

(21) Appl. No.: 19/040,228

(22) Filed: Jan. 29, 2025

(30) Foreign Application Priority Data
Feb. 8, 2024 (FR) 2401239

(51) Int. Cl. H04B 7/04; G01S 13/46; H04W 64/00

(52) U.S. Cl. CPC H04B 7/04013; G01S 13/46; H04W 64/00; G01S 2013/462

(57) ABSTRACT

A method for positioning a set of reconfigurable intelligent surfaces associated with an access point of a telecommunications network. The set includes at least one reconfigurable intelligent surface, called an “intermediate surface” and at least one other reconfigurable intelligent surface, called a “main surface”. The method particularly includes determining positioning data of the intermediate and main surfaces such that signals emitted by the access point are reflected by the intermediate surface toward the main surface to exchange data with at least one user terminal situated in the geographical area served by the main surface, but also such that a path gain of a path taken by said signals between the access point and this user terminal is greater than a predetermined threshold or maximized.

### CROSS REFERENCE TO RELATED APPLICATIONS

The present application claims priority to French Patent Application No FR2401239, filed on Feb. 8, 2024, the content of which is incorporated herein by reference in its entirety.

### TECHNICAL FIELD

The disclosed technology belongs to the general field of wireless communications systems. It more specifically relates to a method for positioning a set of reconfigurable intelligent surfaces. It also relates to an electronic device configured to implement such a method.

### Discussion of Related Technology

In a manner known per se, a Reconfigurable Intelligent Surface, hereinafter referred to as a “RIS” for the sake of brevity, may be defined as a relay configured to receive an incident signal from an emitter and to reflect it in a specific direction. It is generally considered as a relay of “full duplex” type, i.e. which allows simultaneous communication in uplink and downlink.

For this purpose, a RIS comprises a large number of low-cost passive reflecting elements, hereinafter named “reflective elements”, the respective reflective properties of which may be modified in order to improve the performance of a telecommunications network. In particular, the signals reflected by the RIS may be combined constructively to improve the level of power of the signal received by a receiver. By deploying RISs in a network and by intelligently configuring their reflections, the wireless propagation channels between the emitter and the receiver may then be configured dynamically in order to obtain the desired distributions and gains. This configuration of the propagation channels makes it possible to improve the spectral efficiency and coverage of the network, but also to respond to the problem of interference and attenuation of the signals in a wireless network.

The following document describes in more detail the operation of a RIS: “Smart Radio Environments Empowered by Reconfigurable Intelligent Surfaces: How it Works, State of Research, and Road Ahead”, M. D. Renzo, A. Zappone, M. Debbah, M. Alouini, C. Yuen, J. D. Rosny, and S. Tretyakov, IEEE Journal on Selected Areas in Communications, pages 2450-2524, 2020.

In practice, such an RIS is intended to reflect incident radio signals in a passive manner, i.e. without amplification of said incident radio signals by amplifiers (or by low-noise amplifiers or by power amplifiers). By modifying the reflective properties of each reflective element of the RIS, typically by individually modifying the phase shift introduced by each of these reflective elements, it is possible to influence the way in which the incident radio signals are reflected by the RIS and, ultimately, to influence the propagation channel taken by these radio signals.

For this reason, an RIS constitutes an effective means for allowing exchanges of data between an access point to a network such as a base station and geographical areas which would otherwise be poorly served (or not served at all.) This aspect is for example illustrated by FIG. 1 which schematically represents an example of a wireless communication system using an RIS 12.

As illustrated by FIG. 1, the wireless communication system includes a base station 11 installed at the highest point of a tower block, which must exchange data (over a downlink and/or an uplink) with user terminals 13 situated in a geographical area ZG to be served. In this example, the direct paths between the base station 11 and the geographical area ZG to be served are obstructed by buildings, so that the radio signals taking these direct paths are heavily attenuated, or even blocked.

By placing the RIS 12 on an adjacent tower block, it is possible to introduce an additional reflection of the incident radio signals by the RIS placed on this adjacent tower block, and to thus create an indirect path between the geographical area ZG and the base station 11, by way of the RIS 12. For this purpose, a managing device (not shown on FIG. 1, and for example incorporated into the base station 11), determines the appropriate phase shifts of the reflective elements of the RIS 12 to allow this latter to serve the geographical region ZG. Once determined, these phase shifts are transmitted to the RIS 12 via a backhaul network. A command module of the RIS 12 is then used to control the reflective elements so that these latters introduce phase shifts matching those determined by the managing device.

The advantages related to the use of an RIS are not limited to the possibility of serving areas which would otherwise remain poorly served (or not served at all). Specifically, the energy consumption of an RIS is negligible with respect to that of a base station. Furthermore, an RIS is simpler to install from a technical and regulatory point of view. All these aspects justify the high degree of interest in this technology and the desire of operators to boost its development, particularly in the context of the deployment of wireless communication systems of 5G-Advanced or 6G type, particularly suited to the context of spatial multiplexing of different user terminals (multi-user multiple input multiple output or MU-MIMO).

The fact remains that the use of the single RIS 12 to create an indirect path between the base station 11 and the geographical area ZG may not be enough to allow a plurality of terminals to be served with sufficient quality of service.

Specifically, the base station 11 is typically equipped with an array of antennas including a plurality of antennas, and the maximum number of user terminals which can be spatially multiplexed, when the propagation channels are sufficiently decorrelated with one another, corresponds to the minimum out of the number of antennas of the antenna array of the base station 11 and the number of elements of the RIS 12.

In practice, the number of user terminals 13 that can actually be spatially multiplexed depends on the rank of the matrix of the propagation channel between the different user terminals 13 and the different antennas of the antenna array of the base station 11. However, in the case of the wireless communication system of FIG. 1 in which an RIS 12 is used to extend the coverage of a service in situations of very degraded propagation, this rank cannot be greater than the rank of the matrix of the propagation channel between the different antennas of the antenna array of the base station 11 and the different reflective elements of the RIS 12. However, this matrix of the propagation channel between the base station 11 and the RIS 12 can in practice have a fairly low rank, in particular in the case of frequencies greater than 30 GigaHertz (GHz) (for example for millimeter waves), or even greater than 1 TeraHertz (THz), and/or in the situation where the RIS 12 is located in a situation of direct line of sight (LOS) with the base station 11. In a known manner, the quality of transmission between an emitter and a receiver is improved when they are in a situation of direct line of sight. Thus, in such a case, the propagation channel between the base station 11 and the RIS 12 acts as a bottleneck which can greatly limit the achievable performance in terms of spatial multiplexing gains.

To remedy these drawbacks, provision has been made for positioning a plurality of RISs between a base station and a geographical area to be served in which user terminals are able to be located. More specifically, said plurality of RISs includes a so-called “main” RIS and a plurality of so-called “intermediate” RISs:
the main RIS being arranged between the intermediate RISs and the geographical area to be served,
the intermediate RISs being arranged between the base station and the main RISs.

The term “main RIS arranged between the intermediate RISs and the geographical area to be served” should be understood to mean that, in the downlink direction (or in the uplink direction respectively), radio signals coming from each intermediate RIS (or coming from the geographical area respectively) reach the geographical area (or each intermediate RIS respectively) via reflection off said main RIS. Similarly, the term “intermediate RIS arranged between the base station and the main RIS” should be understood to mean that, in the downlink direction (or in the uplink direction respectively) radio signals coming from the base station (or coming from the main RIS respectively) reach the main RIS (or the base station respectively) via reflection off an intermediate RIS.

These considerations result, in particular, in a main RIS being arranged closer to the geographical area to be served than the intermediate RISs. Such a configuration in which a plurality of RISs is used is for example illustrated in FIG. 2.

In FIG. 2, and according to similar considerations to those described above for FIG. 1, the wireless communication system includes a base station 21 which must exchange data with user terminals situated in a geographical area ZG to be served. The wireless communication system further includes a plurality of RISs, namely a main RIS 20_i and three intermediate RISs 20_1, 20_2 and 20_3 (hereinafter written in the form 20_j=1 . . . 3).

As illustrated by FIG. 2, at least some of the radio signals coming from the base station 21 may reach the geographical area ZG by being reflected, first by the intermediate RISs 20_j=1 . . . 3, then by the main RIS 20_i, and conversely, according to the uplink or downlink direction in question.

The introduction of the intermediate RISs 20_j=1 . . . 3 makes it possible to increase the rank of the matrix of the propagation channel between the base station 21 and the main RIS 20_i, by increasing the number of indirect paths usable between said base station 21 and said main RIS 20_i, each intermediate RIS 20_j=1 . . . 3 making it possible to introduce a distinct indirect path between said base station 21 and said main RIS 20_i.

In the prior art, each intermediate surface RIS 20_j=1 . . . 3 is configured to reflect signals toward the main RIS 20_i on the basis of very general assumptions relating to the respective positions of said intermediate 20_j=1 . . . 3 and main 20_i RIS.

### SUMMARY

The disclosed technology makes provision for a solution for positioning RISs which makes it possible to improve the quality of service offered to users situated in a geographical area served by an access point of a network, such as a base station or a Wi-Fi terminal.

For this purpose, according to a first aspect, the disclosed technology relates to a method for positioning a set E of reconfigurable intelligent surfaces associated with an access point of a telecommunications network, at least one reconfigurable intelligent surface of the set E, the so-called “intermediate surface”, being positioned between the access point and at least one other reconfigurable intelligent surface of the set E, the so-called “main surface”, configured to serve a given geographical area, the method being implemented by an electronic device and comprising:
determining positioning data of the intermediate and main surfaces such that:
   signals emitted by the access point are reflected by the intermediate surface toward the main surface to exchange data with at least one user terminal situated in the geographical area served by the main surface,
   a path gain of a path taken by said signals between the access point and said at least one user terminal is greater than a predetermined threshold or maximized, said path gain being a function parameterized by distances between the access point, the intermediate surface and/or the main surface, and/or by angles of said signals coming from the access point and reflected by the intermediate surface toward the main surface; and
processing said positioning data, such as to position said intermediate and main surfaces in accordance with said positioning data.

In a manner known per se, the “path loss” corresponds to the weakening that is undergone by the power of an electromagnetic wave when it travels a certain distance. This weakening is due to the dispersion of the power, but also to the obstacles encountered by the wave on the path (e.g. buildings, weather conditions, Doppler effect etc.). The “path gain” is defined as the inverse of the path loss, and is generally expressed in the form of a ratio of an average reception power to an average transmission power, for omnidirectional and co-polarized transmission/reception antennas.

The fact of determining the positioning of the RISs in this way makes it possible to ensure that the RISs are positioned such that the path loss of a path between the access point and a user terminal is minimized, or in other words, such that the path gain of the path is maximized.

The term “processing of the positioning data” should be understood to mean the transmission, intended for the command modules of the different RIS, of an instruction having the aim of adapting the orientations of the reflective elements of the different RIS in accordance with the determined positioning data. The processing may also comprise the displaying of a 2D or 3D representation of the environment in which the RISs must be positioned, and of the RISs in accordance with the determined positioning data, such as to allow an operator to position said RIS in the environment.

The first aspect of the disclosed technology relates to the scenario of a downlink, during which the signal is emitted by an access point and intended for a user terminal. A second aspect of the disclosed technology relates to the scenario of an uplink, during which the signal is emitted by a user terminal intended for an access point.

More precisely and according to a second aspect, the disclosed technology relates to a method for positioning a set E of reconfigurable intelligent surfaces associated with an access point of a telecommunications network, at least one reconfigurable intelligent surface of the set E, the so-called “intermediate surface”, being positioned between the access point and at least one other reconfigurable intelligent surface of the set E, the so-called “main surface”, configured to serve a given geographical area, the method being implemented by an electronic device and comprising:
determining positioning data of the intermediate and main surfaces such that:
   signals emitted by at least one user terminal situated in the geographical area served by the main surface are reflected by the main surface toward the intermediate surface to exchange data with the access point,
   a path gain of a path taken by said signals between said at least one user terminal and the access point is greater than a predetermined threshold or maximized, said path gain being a function parameterized by distances between the access point, the intermediate surface and/or the main surface, and/or by angles of said signals coming from the main surface and reflected by the intermediate surface toward the access point; and
processing said positioning data, such as to position said intermediate and main surfaces in accordance with said positioning data.

In general, it is considered that the steps of a method must not be interpreted as being related to a concept of succession over time.

In particular modes of implementation, the positioning method according to the first and/or second aspect may further include one or more of the following features, taken in isolation or according to any technically possible combination.

In particular modes of implementation, the positioning data include a distance between the access point and the intermediate surface, a distance between the access point and the main surface, and/or between the intermediate surface and the main surface.

In particular modes of implementation, the positioning data include an orientation of the intermediate surface and/or an orientation of the main surface.

In particular modes of implementation, said determining of positioning data is implemented by considering that each of the surfaces of the subset is an “intermediate surface” (e.g. during a first time period), and by also considering that each of the surfaces of the subset is a “main surface” (e.g. during a second time period distinct from the first time period), each of said surfaces being associated with a given geographical area when it is a “main surface”, each of said surfaces being configured to reflect an incident signal toward the main surface when it is an “intermediate surface”.

These provisions advantageously make it possible to consider different respective roles (intermediate, main) played by each of the surfaces of the set E during different time periods, and a fortiori to improve the quality of service offered to users situated in different geographical areas associated with one and the same access point.

The terms “first time period” and “second time period” are used by arbitrary convention to make it possible to distinguish different time periods, but with no particular chronological order between these time periods.

In particular modes of implementation, the determining is moreover implemented such that the distance between the access point and the intermediate surface and/or the distance between the access point and the main surface and/or the distance between the main surface and the intermediate surface is bounded.

This feature is advantageous in that it makes it possible to take into account spatial restrictions relating to the positioning of these surfaces. Specifically, regulatory and/or contractual restrictions may for example enforce on a manager of RISs—which may be a telecommunications operator—a restricted area in which the RISs can be deployed.

In particular modes of implementation, the determining is moreover implemented such that at least one component of the angle between the access point and the main surface, and/or the angle between the access point and the intermediate surface, and/or the angle between the main surface and the intermediate surface is bounded.

In a similar way to the preceding feature, this feature is advantageous in that it makes it possible to take into account spatial restrictions relating to the positioning of these surfaces.

In particular modes of implementation, the path gain of the path between the access point and said at least one user terminal corresponds to the combination of an antenna gain resulting from the reflection, by the intermediate surface, of (incident) signals emitted by the access point toward the main surface, of a path gain of a path taken by said signals between the access point and the intermediate surface, and of a path gain of a path taken by said signals between the intermediate surface and the main surface, and wherein the antenna gain is a function parameterized by angles of incidence and reflection of the signals, the path gain of the path between the access point and the intermediate surface is a function parameterized by a distance between the access point and the intermediate surface, and the path gain of the path between the intermediate surface and the main surface is a function parameterized by a distance between the intermediate surface and the main surface.

The fact of determining the path gain in this way in the case of a downlink makes it possible to take account of the precise physical reality in which said intermediate surface is located.

This physical reality not only refers to the distances between the surfaces and the base station, but also to the angles “of incidence” of the signals reaching the intermediate surface from the access point, and the angles “of departure” of signals reaching said at least one main surface from the intermediate surface.

In particular modes of implementation, the determining of positioning data is implemented by applying a constrained gradient descent algorithm.

In particular modes of implementation, the applying of the constrained gradient descent algorithm provides a first local optimum, and the determining of positioning data further comprises, following the applying of the constrained gradient descent algorithm:
the applying of an iterative local search algorithm (e.g. tabu search) having as parameter the first local optimum, such as to obtain at least a second local optimum; and
the selecting of a local optimum from among said first and at least a second local optima, the selected local optimum corresponding to the determined positioning data.

In particular modes of implementation, the access point is in a situation of direct line of sight with all or part of the intermediate surface, and/or the main surface is in a situation of direct line of sight with all or part of the associated geographical area it serves, and/or all or part of the main surface is in a situation of direct line of sight with all or part of the intermediate surface.

In particular modes of implementation, a plurality of intermediate surfaces are to be positioned between the access point and the main surface, and the determining of positioning data is implemented such that the intermediate surfaces are arranged along different respective directions with respect to the access point.

In particular modes of implementation, the method is implemented to position a plurality of intermediate surfaces between the access point and the main surface, and the determining of positioning data is implemented such that the intermediate surfaces are arranged along different respective directions with respect to the main surface.

According to a third aspect, the disclosed technology relates to an electronic managing device configured to implement the method for positioning a set E of reconfigurable intelligent surfaces according to the disclosed technology.

According to a fourth aspect, the disclosed technology relates to a wireless communication system including an access point, a plurality of reconfigurable intelligent surfaces associated with said access point, and also an electronic managing device according to the disclosed technology.

According to a fifth aspect, the disclosed technology relates to a computer program including instructions for implementing a positioning method according to the disclosed technology when said program is executed by a processor.

This program can use any programming language, and be in the form of source code, object code, or intermediate code between source code and object code, such as in a partially compiled form, or in any other desirable form.

According to a sixth aspect, the disclosed technology relates to an information or recording medium readable by a computer on which is recorded a computer program according to the disclosed technology.

The information or recording medium can be any entity or device capable of storing the program. For example the support may include a storage means, such as a ROM, for example a CD-ROM or a microelectronic circuit ROM, or else a magnetic recording means, for example a hard disk.

Moreover, the information or recording medium can be a transmissible medium such as an electrical or optical signal, which can be conveyed via an electrical or optical cable, by radio or by other means. The program according to the disclosed technology can in particular be downloaded over a network of Internet type.

Alternatively, the information or recording medium can be an integrated circuit into which the program is incorporated, the circuit being suitable for executing or for being used in the execution of the method in question.

### BRIEF DESCRIPTION OF THE DRAWINGS

Other features and advantages of this disclosed technology will become apparent from the description given below, with reference to the appended drawings which illustrate an exemplary embodiment thereof, without any limitation. On the figures:

FIG. 1, already described, schematically represents an example of a wireless communication system of the prior art, in which a single RIS is used to serve a given geographical area;

FIG. 2, already described, schematically represents an example of a wireless communication system of the prior art, in which a plurality of intermediate RISs and a main RIS are used to serve a given geographical area;

FIG. 3 schematically represents a wireless communication system according to a particular embodiment of the disclosed technology;

FIG. 4 is an alternative schematic representation of FIG. 3, in which RISs belonging to the wireless communication system are respectively associated with geographical areas to be served;

FIG. 5 represents modules embedded in a managing device, such as the managing device belonging to the system of FIG. 3, according to an exemplary implementation of the disclosed technology;

FIG. 6 schematically represents an example of a hardware architecture of a managing device belonging to the wireless communication system of FIG. 3;

FIG. 7 represents, in the form of a block diagram, a particular mode of implementation of a positioning method, for example executed by the electronic device of FIG. 5; and

FIG. 8 is a geometrical representation of a wireless communication system according to a particular embodiment of the disclosed technology.

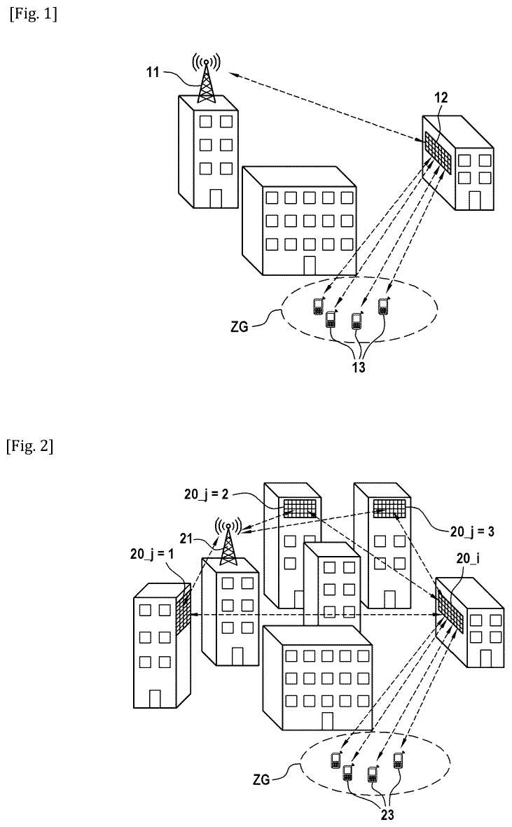

### DESCRIPTION OF EXEMPLARY EMBODIMENTS

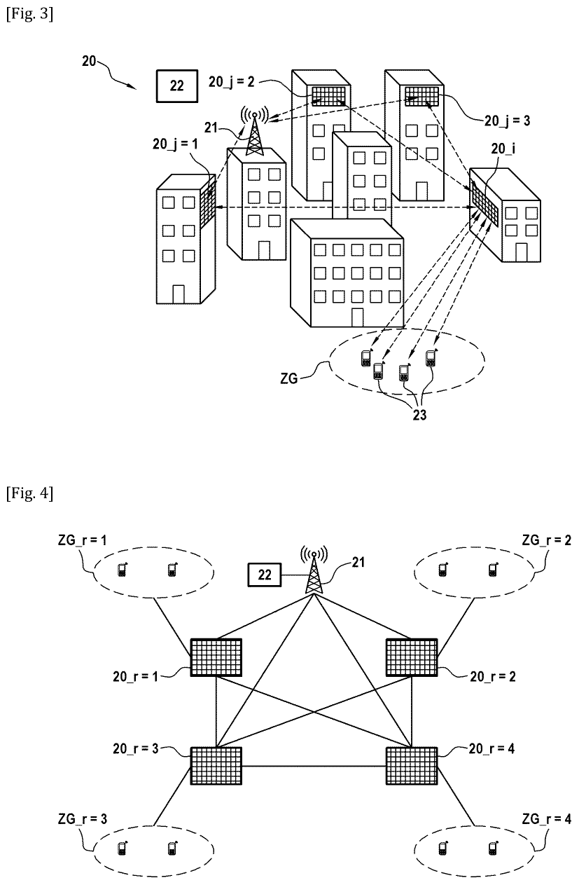

FIG. 3 schematically represents a wireless communication system 20 according to a particular embodiment of the disclosed technology.

The system 20 is based on the configuration already described above with reference to FIG. 2. Consequently, the elements mentioned in relation to FIG. 2 are repeated here with identical reference numbers.

Thus, and as illustrated by FIG. 3, the system 20 includes an access point taking the form of a base station 21, a main RIS 20_i configured to serve a given geographical area ZG of said communication cell, as well as a number of intermediate RISs 20_j=1 . . . 3. The plurality of RISs belonging to the system 20 together form a set of RISs hereinafter written as “set E”.

The integer index i is used here to denote the main RIS or RISs of the set E, and the integer index j, between 1 and 3, denotes the intermediate RISs of the set E.

As mentioned above, each intermediate RIS 20_j=1 . . . 3 thus makes it possible to establish a distinct indirect path between the base station 21 and the geographical area ZG, the main RIS 20_i being located on a plurality of such distinct indirect paths established by the different intermediate RISs 20_j=1 . . . 3.

It should be noted that the fact of considering three intermediate RISs 20_j=1 . . . 3 constitutes only one variant implementation of the disclosed technology. In general, no limit is attached to the number of intermediate RISs which may be envisioned, for example more or less than three intermediate RISs, particularly a single intermediate RIS.

Moreover, and although only one main RIS 20_i is envisioned in this embodiment, the disclosed technology covers yet other embodiments in which several main RISs may be envisioned. For example, the number of main RISs can be less than or equal to the number of intermediate RISs, thus limiting the number of propagation channels between the main RISs and the user terminals to be served.

According to similar considerations, the system 20 may also include a plurality of base stations, and each base station may serve one or more communication cells. In practice, the principles described hereinafter can be extended by those skilled in the art to such configurations.

The base station 21 includes an array of antennas (not shown on the figures) including an integer number M>1 of antennas. The antenna array is for example a uniform linear array (or ULA) in which the M antennas are arranged with a constant separation along one dimension, or else a uniform rectangular planar array (or URPA) in which the M antennas are coplanar and arranged along two dimensions with constant respective separations.

Moreover, it is considered without any limitation that each user terminal is equipped, in the example envisioned here, with a single antenna. The disclosed technology is of course not limited to the case where each user terminal is equipped with a single antenna. Thus, nothing precludes the envisioning of one or more user terminals situated in the geographical area ZG being equipped with several antennas.

A user terminal can for example take the form of a mobile phone, such as a smart mobile phone (or smartphone), a digital tablet, a laptop computer, a personal assistant, a connected watch, an electronic reader, etc. In general, no limitation is attached to the form taken by a user terminal.

Furthermore, each RIS includes a command module (not shown on the figures) and reflective elements (not shown on the figures), reflective properties of which are modifiable by the command module so as to influence the way radio signals incident on said reflective elements are reflected thereby.

The rank of the matrix of the propagation channel between the base station 21 and the main RIS 20_i can be improved if the intermediate RISs 20_j=1 . . . 3 are spatially distributed with respect to the base station 21 and/or with respect to the main RIS 20_i, i.e. if said intermediate RISs 20_j=1 . . . 3 are arranged in different respective directions with respect to:
the base station 21, i.e. if the angle measured at the base station 21 between the directions of two intermediate RISs (e.g., 20_j=1 and 20_j=2) is non-zero (for example greater than 5° or greater than 10°) for each pair of intermediate RISs; and/or
the main RIS 20_i, i.e. if the angle measured at the main RIS 20_i between the directions of two intermediate RISs (e.g., 20_j=1 and 20_j=2) is non-zero (for example greater than 5° or greater than 10°) for each pair of intermediate RISs.

Note that the direction of an intermediate RIS 20_j with respect to the base station 21 (or with respect to the main RIS 20_i respectively) corresponds to the direction along which radio signals emitted by the base station 21 (or reflected by the intermediate RIS 20_j respectively) arrive at said intermediate RIS 20_j (or depart from the intermediate RIS 20_j respectively) to be reflected toward the main RIS 20_i. In other words, it is the direction of the vector connecting the base station 21 (or the intermediate RIS 20_j respectively) to the intermediate RIS 20_j (or to the main RIS 20_i respectively) in a situation of direct line of sight (LOS). This vector can in particular be characterized angularly by means of different components (elevation, azimuth, and optionally polarization).

It should however be noted that, if there is no direct path between the base station 21 (or the intermediate RIS 20_j respectively) and the intermediate RIS 20_j (or the main RIS 20_i respectively), the direction between these two entities is then defined based on the main indirect path (i.e. the most energetic) connecting them.

Preferably, in particular in the scenario in which the exchanges of data with the user terminals use high frequencies (for example greater than 30 GHz, or even greater than 1 THz):
the base station 21 is in a situation of direct line of sight (LOS) with all or part of the intermediate RISs 20_j, and/or
the main RIS 20_i is in a situation of direct line of sight (LOS) with all or part of the geographical area ZG to be served, and/or
the main RIS 20_i is in a situation of direct line of sight (LOS) with all or part of the intermediate RISs 20_j.

As set out in more detail hereinafter, optimal positions of the different RISs are determined, for example by solving an optimization problem. In this regard, in the context of this disclosed technology, it is considered that the RISs of the set E are mobile—i.e. their position and/or orientation can vary. These changes of position and/or orientation are for example made manually by an operator, or using means allowing the RISs to change position and/or orientation. The term “change of position”, should be understood to mean a movement of the RIS in a plane defined by the ground and/or a change in their height. Their respective positions result from such a procedure consisting seeking appropriate sites, while taking care to maximize a path gain of a path taken by the signals between the base station 21 and the user terminals 23 (or at least to ensure that this gain is greater than a threshold value which can be predetermined or not).

As indicated above, the wireless communication system 20 also includes an electronic managing device 22 configured to determine positioning data of the RISs of a set E of RIS, by implementing a positioning method according to the disclosed technology.

As illustrated in FIG. 3, the managing device 22 is an electronic device distinct from the RISs of the set E and also from the base station 21. In particular modes of implementation, the managing device is a terminal which for example takes the form of a mobile telephone, such as a smart mobile telephone (or “smartphone”), a digital tablet, a laptop computer, or a personal assistant. In a variant, this managing device 22 is for example incorporated into the base station 21.

FIG. 4 is an alternative schematic representation of FIG. 3, in which RISs belonging to the wireless communication system are respectively associated with geographical areas to be served.

As illustrated in FIG. 4, the geographical areas ZG_r=1 . . . 4 respectively associated with the RIS 20_r=1 . . . 4 of the set E are distinct from one another. Moreover, the RISs 20_r=1 . . . 4 of the set E are connected to one another in FIG. 4 by lines symbolizing (distinct) indirect paths between the base station 21 and the different geographical areas ZG_r=1 . . . 4 according to whether such and such a RIS plays a role of intermediate RIS or of main RIS.

More precisely, insofar as each RIS of the set E is able to play a role of main RIS, each of said RIS is associated with a given geographical area ZG (for example of a cell) covered by the base station 21 and is intended to serve this latter when the role of main RIS is effectively assigned to it. The geographical areas ZG respectively associated with the RIS of the set E may be disjunct or overlap. Furthermore, each RIS, the role of which is determined as being that of an intermediate RIS is then associated with at least one RIS, the role of which is determined as being that of a main RIS, for the purpose of reflecting toward it incident signals coming from the base station 21 in the scenario of a downlink.

To be able to implement this configuration in which several geographical areas are covered, the roles respectively played by the deployed RISs (i.e. a role of intermediate RIS or else a role of main RIS) are modified over time, for example taking care to optimize a communication performance criterion for antennas situated in the geographical area served by each surface, the role of which is determined as being that of main surface.

This communication performance criterion is for example representative of at least one from among:
a bitrate of the data which can be exchanged between the base station and the antennas situated in the geographical area served by each main surface;
a level of quality of service of the exchanges of data which can be exchanged between the base station and the antennas situated in the geographical area served by each main surface;
an energy efficiency of the exchanges of data between the base station and the antennas situated in the geographical area served by each main surface; and
a signal-to-noise ratio of the exchanges of data between the base station and the antennas situated in the geographical area served by each main surface.

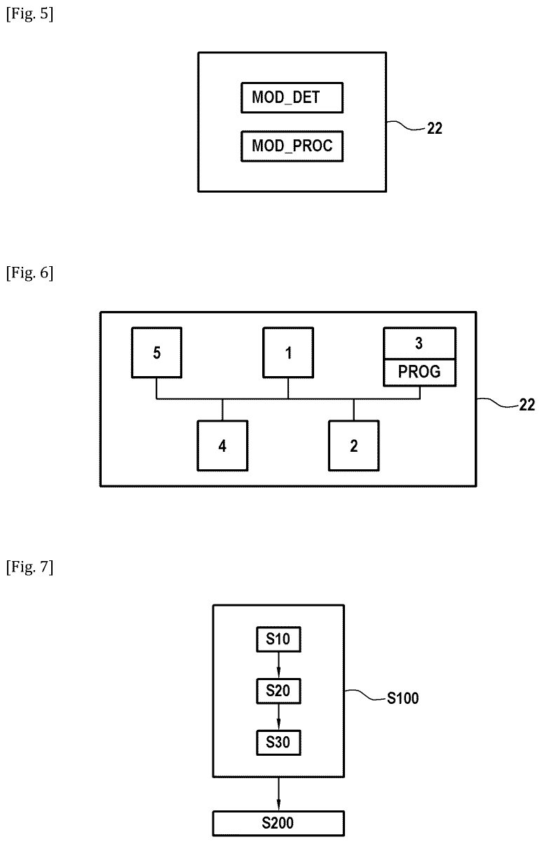

FIG. 5 represents modules embedded into a managing device, such as the managing device 22 belonging to the system 20 of FIG. 3, according to an exemplary implementation of the disclosed technology.

As illustrated by FIG. 5, the managing device 22 in particular comprises a module MOD_DET for determining positioning data of the intermediate and main surfaces, and a module MOD_PROC for processing said positioning data, the functionalities of which are described in more detail with reference to FIGS. 6 and 7.

FIG. 6 schematically represents an example of hardware architecture of the managing device 22 belonging to the system 20 of FIG. 3.

As illustrated by FIG. 6, the managing device 22 has the hardware architecture of a computer. Thus, the managing device 22 includes, in particular, a processor 1, a random-access memory 2, a read-only memory 3 and a non-volatile memory 4. It also has communication means 5.

The read-only memory 3 of the control device 22 constitutes a recording medium in accordance with the disclosed technology, readable by the processor 1 and on which is recorded a computer program PROG in accordance with the disclosed technology, including instructions for executing steps of the positioning method. The program PROG defines functional modules of the managing device 22, which are based on or command the hardware elements 1 to 5 of the managing device 22 mentioned previously. These functional modules are illustrated on FIG. 5 without any limitation, and are described in more detail below with reference to different modes of implementation

In particular modes of implementation, the communication means 5 in particular allow the managing device 22 to exchange data with any equipment item of the wireless communication system 20, including in particular the intermediate RISs 20_j and the main RIS 20_i of the set E via a backhaul network. For this purpose, the communication means 5 include a communication interface, wired or wireless, able to implement any suitable protocol known to those skilled in the art.

FIG. 7 represents, in the form of a block diagram, a particular mode of implementation of the positioning method executed by the managing device 22.

In this mode of implementation, the positioning method includes a first step S100 of determining positioning data of the intermediate and main surfaces such that signals emitted by the base station 21 are reflected by the intermediate surface 20_j toward the main surface 20_i to exchange data with antennas 23 situated in the geographical area served by the main surface.

Moreover, said positioning data are determined such that the path gain PG_{21→20_j→20_i} of a path taken by said signals between the base station 21 and the antennas 23 is greater than a predetermined threshold or maximized.

To do this, the path gain is considered as being a function parameterized by distances between the base station, the intermediate surface and/or the main surface, and/or by angles of the signals reflected by the intermediate surface toward the main surface.

Ultimately, the determining of the positioning data can be done by solving an optimization problem making it possible to determine the optimal positions of deployment or installation of the RISs of the set E, These optimal positions for example include the distances between the RISs of this set E and the base station 21, the distances between the RISs themselves, the orientation of the RISs of this set E with respect to the base station 21, and/or the orientation of the RISs of this set E with respect to one another. This step S100 is for example implemented by the module MOD_DET of the managing device 22.

The orientations are for example formalized in “vector of angles of incidence” and “vector of angles of arrival” form, described in more detail hereinafter.

For the remainder of the description of the positioning method, the following notations are introduced.

Ψ_{a,21→20_j} (also written Ψₐ) denotes a vector, the so-called “vector of angles of incidence”, corresponding to the direction of an incident wave coming from the base station 21 and directed toward an intermediate RIS 20_j. This vector includes three components θ_{a,21→20_j}, ϕ_{a,21→20_j}, ω_{a,21→20_j} respectively corresponding to the elevation, azimuth and polarization associated with said direction.

Ψ_{d,20_j→20_i} also written Ψ_{d}) denotes a vector, the so-called “vector of angles of departure”, corresponding to the direction of a wave reflected by an intermediate RIS 20_j toward the main RIS 20_i. This vector includes two components θ_{d,20_j→20_i}, ϕ_{d,20_j→20_i} respectively corresponding to the elevation and azimuth associated with said direction.

d_{a→b} denotes a distance between the entities a and b, each of these entities corresponding either to a base station or to a RIS.

x and z correspond to directions representative of the main directions in which an intermediate RIS 20_j extends, the direction written y being that orthogonal to the plane formed by the directions x and z. Thus, the axes bearing the directions x and z form a frame of reference attached to the intermediate RIS 20_j.

$${B}_{x} ( {ψ}_{a , 21 \to 20 \_ j} ) = sin {θ}_{a , 21 \to 20 \_ j} cos {ϕ}_{a , 21 \to 20 \_ j}$$

$${B}_{y} ( {ψ}_{a , 21 \to 20 \_ j} ) = sin {θ}_{a , 21 \to 20 \_ j} sin {ϕ}_{a , 21 \to 20 \_ j}$$

$${B}_{z} ( {ψ}_{a , 21 \to 20 \_ j} ) = cos {θ}_{a , 21 \to 20 \_ j}$$

$${B}_{x} ( {ψ}_{d , 20 \_ j \to 20 \_ i} ) = sin {θ}_{d , 20 \_ j \to 20 \_ i} cos {ϕ}_{d , 20 \_ j \to 20 \_ i}$$

$${B}_{y} ( {ψ}_{d , 20 \_ j \to 20 \_ i} ) = sin {θ}_{d , 20 \_ j \to 20 \_ i} sin {ϕ}_{d , 20 \_ j \to 20 \_ i}$$

$${B}_{z} ( {ψ}_{d , 20 \_ j \to 20 \_ i} ) = cos {θ}_{d , 20 \_ j \to 20 \_ i}$$

$${B}_{p} = {B}_{p} ( {ψ}_{a , 21 \to 20 \_ j} ) + {B}_{p} ( {ψ}_{d , 20 \_ j \to 20 \_ i} ) , ∀ p ∈ \{ x , y , z \}$$

$${B}_{x , z} = cos {ω}_{a , 21 \to 20 \_ j} {B}_{x} ( {ψ}_{a , 21 \to 20 \_ j} ) + sin {ω}_{a , 21 \to 20 \_ j} {B}_{z} ( {ψ}_{a , 21 \to 20 \_ j} )$$

Q_{20_j} denotes a diagonal matrix representative of the phase shifts applied to each of the N_{20_j} reflective elements of an intermediate RIS 20_j, and can be expressed in the following form:

$${Q}_{20 \_ j} = diag ( \overline{{g}_{20 \_ J} ( {Ψ}_{a} , {Ψ}_{d} )} {e}^{i {φ}_{20 \_ j , 1}} , … , \overline{{g}_{20 \_ J} ( {Ψ}_{a} , {Ψ}_{d} )} {e}^{i {φ}_{20 \_ j , {N}_{20 \_ j}}} )$$

an expression in which:
i is the complex number which when squared is equal to −1,
φ_{20_j,k} corresponds to the phase shift introduced by the reflective element of index k of the intermediate RIS 20_j (k=1, . . . , N_{20_j}),

$$\overline{- {g}_{20 \_ J} ( {Ψ}_{a} , {Ψ}_{d} )} = \frac{\sqrt{4 π}}{λ} - {g}_{20 \_ j} ( {Ψ}_{a} , {Ψ}_{d} ) ,$$

where λ corresponds to the wavelength,

$$- {g}_{20 \_ j} ( {Ψ}_{a} , {Ψ}_{d} ) , = \frac{i \sqrt{4 π} \times τ \times {L}_{20 \_ j}^{2}}{λ} ( {Ψ}_{a} , {Ψ}_{d} ) sinc ( \frac{π {L}_{20 \_ j} {B}_{x}}{λ} ) sinc ( \frac{π {L}_{20 \_ j} {B}_{z}}{λ} ) ,$$

where sinc
corresponds to the cardinal sine function, and τ corresponds to a reflection coefficient of each reflective element of the intermediate RIS 20_j (this coefficient τ is between 0 and 1, and is assumed constant for all the reflective elements in this mode of implementation). [symbol] (Ψₐ, Ψ_{d}) is equal to the following quantity:

$$\frac{{B}_{y}}{\sqrt{{B}_{x , z}^{2} + {B}_{y}^{2}}} {‖ \begin{matrix}cos {θ}_{20 \_ j \to 20 \_ i} ( cos {ω}_{21 \to 20 \_ j} sin {ϕ}_{20 \_ j \to 20 \_ i} - sin {ω}_{21 \to 20 \_ j} cos {ϕ}_{20 \_ j \to 20 \_ i} ) \\ sin {ω}_{21 \to 20 \_ j} sin {θ}_{21 \to 20 \_ j} + cos {ω}_{21 \to 20 \_ j} cos {ϕ}_{21 \to 20 \_ i}\end{matrix} ‖}_{2}$$

where ∥⋅∥₂ denotes the Euclidian norm.

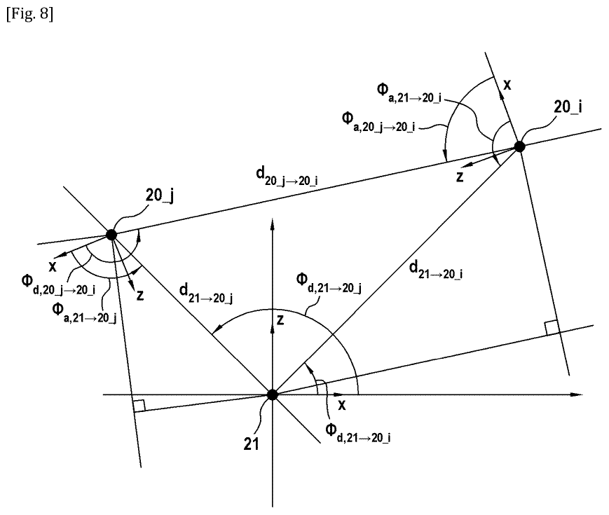

For the sake of simplicity, this optimization problem can be expressed in two dimensions, when the base station 21 and the RISs of the set E all have one and the same height. In this scenario, this optimization problem equates to determining the distances and azimuths of the RIS, all the elevations then having the value of 90°. Of course, this special case in no way limits the scope of the disclosed technology. These aspects are in particular represented schematically and by way of example solely in FIG. 8.

According to a first embodiment, the optimization problem described previously has the aim of determining the optimal positions of installation of the RISs of the set E, such that the path gain PG₂₁₂₀_j->2₀_i of a path taken by said signals between the base station 21 and the antennas 23 via the intermediate and main RISs is maximized. In other words, this first embodiment aims to determine the optimal positions of installation of the RISs of the set E, such that the energy of the incident signal coming from the base station 21 and reflected by the intermediate surface 20_j toward the main surface 20_i is maximized.

The optimization problem then consists in determining the optimization variables such that:

$${max v}_{{d}_{21 \to 20 \_ i} , {d}_{20 \_ i \to 20 \_ j} , {ϕ}_{a , 21 \to 20 \_ j} , {ϕ}_{d , 21 \to 20 \_ j} , {ϕ}_{a , 20 \to 20 \_ j} , {ϕ}_{d , 20 \_ i \to 20 \_ j} , v , ∀ i , j , i \neq j ,}$$

$$such that$$

$${PG}_{21 \to 20 \_ j \to 20 \_ i} > v , ∀ i , j , i \neq 1 \qquad ( C0\_DL )$$

$${d}_{20 \_ i \to 20 \_ j}^{2} = {d}_{21 \to 20 \_ i}^{2} + {d}_{21 \to 20 \_ j}^{2} - 2 {d}_{21 \to 20 \_ i} {d}_{21 \to 20 \_ j} cos ( {ϕ}_{d , 21 \to 20 \_ j} - {ϕ}_{d , 21 \to 20 \_ i} ) , ∀ i , j , i \neq j \qquad ( C1 )$$

$${d}_{21 \to 20 \_ i}^{2} = {d}_{2 {0}_{-} i \to 20 \_ j}^{2} + {d}_{21 \to 20 \_ j}^{2} - 2 {d}_{21 \to 20 \_ j} {d}_{20 \_ i \to 20 \_ j} cos ( {ϕ}_{d , 20 \_ j \to 20 \_ i} - {ϕ}_{a , 21 \to 20 \_ j} ) , ∀ i , j , i \neq j \qquad ( C2 )$$

$${d}_{21 \to 20 \_ j}^{2} = {d}_{20 \_ i \to 20 \_ j}^{2} + {d}_{21 \to 20 \_ i}^{2} - 2 {d}_{20 \_ i \to 20 \_ j} {d}_{21 \to 20 \_ i} cos ( {ϕ}_{a , 21 \to 20 \_ i} - {ϕ}_{a , 20 \_ j \to 20 \_ i} ) , ∀ i , j , i \neq j \qquad ( C3 )$$

$${d}_{20 \_ i \to 20 \_ j} = {d}_{20 \_ j \to 20 \_ i} , ∀ i , j , i \neq j \qquad ( C4 )$$

$${ϕ}_{d , 20 \_ j \to 20 \_ i} = {ϕ}_{a , 20 \_ i \to 20 \_ j} , ∀ i , j , i \neq j \qquad ( C5 )$$

The constraints C1 to C3 are geometrical constraints of computation of distances in a plane. At this stage it is important to recall that the distances and angles referenced are in particular represented schematically in FIG. 8.

The constraint C4 expresses the intuitive concept of symmetry of a distance, and is advantageous in that it makes it possible to simplify the expressions, and thus to facilitate the solving of this optimization problem.

Finally, the constraint C5 expresses the fact that the azimuth of a wave reflected by the RIS 20_j and directed toward the RIS 20_i is equal to the azimuth of an incident wave coming from the RIS 20_i and directed toward the RIS 20_j.

The angle ϕ_{a,20_i→20_j} has no physical significance in the scenario in which the wave is emitted by the base station 21, then reflected by the RIS 20_j (playing the role of intermediate RIS) toward the RIS 20_i (playing the role of main RIS).

However, according to a particular implementation, the respective roles (e.g. “intermediate”, “main”) played by the RISs of the set E can be modified. Each RIS, the role of which is determined as being an intermediate RIS is then associated with at least one RIS, the role of which is determined as being a main RIS, for the purpose of reflecting toward it incident signals coming from the base station 21. Moreover, insofar as each RIS of the set E is able to play a role of main RIS, each of said RIS is associated with a given geographical area ZG of the cell covered by the base station 21 and is intended to serve this latter when the role of main RIS is effectively assigned to it. The geographical areas ZG respectively associated with the RIS of the set E are distinct from one another. These aspects are in particular schematically represented by way of example solely in FIG. 8.

According to this particular implementation, this angle ϕ_{a,20_i→20_j} therefore acquires its full significance when the wave is reflected by the RIS 20_i (which then plays the role of intermediate RIS) toward the RIS 20_j (and which then plays, for example, the role of main RIS).

According to another particular implementation described in more detail hereinafter, the transmission of data under consideration is not solely a downlink communication, but a communication of “full duplex” type, and this angle ϕ_{a,20_i→20_j} therefore also acquires its full significance in the scenario of an uplink, i.e., when the wave is reflected by the RIS 20_i toward the RIS 20_j for the purpose of reaching the base station 21.

According to a second embodiment, the optimization problem described previously has the aim of determining the optimal positions of installation of the RISs of the set E, such that the path gain PG_{21→20_j→20_i} of a path taken by said signals between the base station 21 and the antennas 23 via the intermediate and main RISs is greater than a threshold value v, this threshold value being determined prior to the solving of this optimization problem. In other words, this second embodiment has the aim of determining the optimal positions of installation of the RISs of the set E, such that the energy of the incident signal coming from the base station 21 and reflected by the intermediate surface(s) 20_j toward the main surface 20_i is greater than a threshold value.

The optimization problem to be solved consists in finding

$${d}_{21 \to 20 \_ i} , {d}_{20 \_ i \to 20 \_ j} , {ϕ}_{a , 21 \to 20 \_ j} , {ϕ}_{d , 21 \to 20 \_ j} , {ϕ}_{a , 20 \_ i \to 20 \_ j} , {ϕ}_{d , 20 \_ i \to 20 \_ j} , ∀ i , j , i \neq j ,$$

$$such that :$$

$${PG}_{21 \to 20 \_ j \to 20 \_ i} > v , ∀ i , j , i \neq j ,$$

with the constraints C1 to C5 described previously.

In other words, unlike the first embodiment in which the variable v was determined during the solving of this optimization problem, this variable v is this time determined prior to the solving of this optimization problem.

In particular modes of implementation, the distance between the base station 21 and the intermediate surface 20_j and/or the distance between the base station 21 and the main surface 20_i and/or the distance between the main surface 20_i and the intermediate surface 20_j is bounded.

In this case, the optimization problem comprises additional constraints referenced C6 to C8 hereinafter:

$${d}_{21 \to 20 \_ {i}_{min}} < {d}_{21 \to 20 \_ i} < {d}_{21 \to 20 \_ {i}_{max}} , ∀ i , \qquad ( C6 )$$

$${d}_{20 \_ i \to 20 \_ {j}_{min}} < {d}_{20 \_ i \to 20 \_ j} < {d}_{20 \_ i \to 20 \_ {j}_{max}} , ∀ i , j , i \neq j , \qquad ( C7 )$$

$${d}_{21 \to 20 \_ {j}_{min}} < {d}_{21 \to 20 \_ j} < {d}_{21 \to 20 \_ {j}_{max}} , ∀ i , \qquad ( C8 )$$

In particular modes of implementation, the azimuths of the angle of incidence ϕ_{a,21→20_i} of a wave coming from the base station 21 and directed toward the RIS 20_i, of the angle ϕ_{d,21→20_i} of a wave emitted by the base station 21 toward the RIS 20_i, of the angle of incidence ϕ_{a,20_i→20_j} of a wave coming from the RIS 20_i and directed toward the RIS20_j and of the angle ϕ_{a,20_i→20_j} of a wave emitted by the RIS 20_i toward the RIS 20_j are bounded.

In this case, the optimization problem comprises an additional constraint referenced C9 hereinafter:

$${ϕ}_{min} < {ϕ}_{a , 21 \to 20 \_ i} , {ϕ}_{d , 21 \to 20 \_ i} , {ϕ}_{a , 20 \_ i \to 20 \_ j} , {ϕ}_{d , 20 \_ i \to 20 \_ j} < {ϕ}_{max} ∀ i , j , i \neq j \qquad ( C9 )$$

The path gain PG_{21→20_j→20_i} of a path taken by said signals between the base station 21 and the antennas 23 via the intermediate RIS 20_j and the main RIS 20_i corresponds to the combination of an antenna gain (G_{20_j}) resulting from the reflection, by the intermediate surface 20_j, of incident signals emitted by the base station 21 toward the main surface 20_i, of a path gain PG_{21→20_}j of a path taken by said signals between the base station 21 and the intermediate surface 20_j, and a path gain PG_{a,20_j→20_i} of a path taken by said signals between the intermediate surface 20_j and the main surface 20_i.

Moreover, the antenna gain (G_{20_j}) is a function parameterized by angles of incidence (ψ_{21→20_j}) and reflection (ψ_{20_j→20_i}) of the signals. Moreover, the path gain (PG_{21→20_j}) of the path between the base station (21) and the intermediate surface (20_j) is a function parameterized by a distance (d_{21→20_j}) between the base station 21 and the intermediate surface 20_j, and the path gain (PG_{20_j→20_i}) of the path between the intermediate surface 20_j and the main surface 20_i is a function parameterized by a distance (d_{20_j→20_i}) between the intermediate surface 20_j and the main surface 20_i.

Thus, the path gain PG_{21→20_j→20_i} is expressed as follows:

$${PG}_{21 \to 20 \_ j \to 20 \_ i} = {G}_{20 \_ j} {PG}_{21 \to 20 \_ j} ( {d}_{21 \to 20 \_ j} ) {PG}_{20 \_ j \to 20 \_ i} ( {d}_{20 \_ j \to 20 \_ i} ) \qquad ( E 1 )$$

$$with$$

$${G}_{20 \_ j} = {\vert {g}_{j} ( {Ψ}_{a , 21 \to 20 \_ j} , {Ψ}_{d , 20 \_ j \to 20 \_ i} ) \vert}^{2}$$

By considering that the intermediate RIS 20_j reflects, towards the main RIS 20_i, incident signals coming from the base station 21, the expression then becomes:

$${\vert {g}_{j} ( {Ψ}_{a , 21 \to 20 \_ j} , {Ψ}_{d , 20 \_ j \to 20 \_ i} ) \vert}^{2} = {N}_{j}^{2} {\vert \overline{{g}_{20 \_ j} ( {Ψ}_{a , 21 \to 20 \_ j} , {Ψ}_{d , 20 \_ j \to 20 \_ i}} \vert}^{2}$$

Moreover, in order to simplify the solving of this optimization problem, it can for example be considered that the electromagnetic waves propagate “in free space” between the base station 21 and the intermediate RIS 20_j, and between the intermediate RIS 20_j and the main RIS 20_i.

In this case, the path gain PG_{21→20_j}(d_{21→20_j}) is expressed as a function of

$${( \frac{λ}{4 π {d}_{21 \to 20 \_ j}} )}^{2} .$$

Thus, the path gain PG_{21→20_j}(d_{21→20_j}) is for example equal to

$${( \frac{λ}{4 π {d}_{21 \to 20 \_ j}} )}^{2} .$$

Symmetrically, the path gain PG_{20_j→20_i}(d_{20_j→20_i}) is for example equal to

$${( \frac{λ}{4 π {d}_{20 \_ j \to 20 \_ i}} )}^{2} .$$

Any method of optimization known to those skilled in the art to solve such a problem may be envisioned, the choice of a particular method corresponding to only one variant implementation of the disclosed technology.

According to a particular mode of implementation, the determining S100 of positioning data is implemented by applying S10 a gradient descent algorithm comprising the following steps:
the obtaining of an initial position of the main RIS and intermediate RIS(s). This initial position is for example predetermined, but can also be selected at random;
at each iteration k, the updating of a vector xₖ representative of all the optimization variables described previously, using the gradient of the Lagrange function such that xₖ₊₁=xₖ+αₖ∇ₓL(xₖ, λₖ, Γₖ), with L(xₖ, λₖ, Γₖ) the Lagrange function, αₖ the size of the increment, and λₖ, Γₖ the Lagrange multipliers corresponding to the constraints in terms of inequality and equality at the iteration k; then the updating of the Lagrange multipliers λₖ, Γₖ, for example using the Karush-Kuhn-Tucker conditions.

The updating steps are reiterated as long as a stopping criterion has not been reached. This stopping criterion for example corresponds to a predetermined number of iterations to be reached or to a convergence criterion. According to a particular implementation, the convergence criterion is considered as being reached when the distance between a resultant obtained at the iteration k and at least one other resultant obtained at a preceding iteration, for example at the iteration k−1, is less than a certain threshold. This distance for example corresponds to a Euclidian distance.

However, in certain modes of implementation, the positioning data obtained by applying this constrained gradient descent algorithm do not necessarily correspond to a global optimum, but rather to a local optimum (referred to as “first local optimum” hereinafter). Specifically, the solution determined by a gradient descent algorithm is generally closely related to the initial position.

In this particular case, the determining S100 of positioning data further comprises a step S20 during which an iterative local search algorithm having the first local optimum as parameter is implemented, so as to obtain one or more second local optima.

This local search algorithm for example corresponds to a tabu search algorithm. In a known manner, a tabu search algorithm explores the vicinity of a given position (here the first local optimum) and for example chooses the position in this vicinity which maximizes a cost function.

Following the applying of the step 20, a local optimum is selected during a step S30 from among said first and second local optima, and the selected local optimum then corresponds to the positioning data determined during this step S100. The selected local optimum is for example the one that generates the most optimal cost function.

The method for positioning a set E of reconfigurable intelligent surfaces finally comprises a step S200 during which the positioning data are processed, so as to position said intermediate 20_j and main 20_i surfaces in accordance with said positioning data. This step is for example implemented by the module MOD_PROC of the managing device 22.

According to a particular implementation, this processing step comprises the transmitting, to the command modules of the different RIS, of an instruction having the aim of adapting the orientations of the reflective elements of the different RIS in accordance with the determined positioning data.

According to another particular implementation, the surfaces RISs are mobile and/or are positioned on means allowing the RIS to move. In this case, this processing step comprises the transmitting, to the command modules of the different RIS, of an instruction having the aim of adapting the positions of the different RIS in accordance with the determined positioning data.

According to another particular implementation, the processing comprises the displaying of a 2D or 3D representation of the environment in which the RISs must be positioned, and the overlaying of the RISs on this representation, in accordance with the determined positioning data, such as to allow an operator to position said RIS in the environment.

It is important to note that, according to yet other modes of implementation of the positioning method, the positions of the RISs can be determined by combining all or part of the optimization problems described previously. Put still otherwise, all the constraints C1 to C9 mentioned previously can be taken into account according to any technically operable combination.

The disclosed technology has until now been mainly described in the scenario of a communication downlink. But the disclosed technology is no less applicable in the scenario of a communication uplink or in the scenario of a communication of full duplex type. In this latter scenario (“full duplex”), the first embodiment described previously then comprises an additional constraint C0_UL:

$${PG}_{20 \_ i \to 20 \_ j \to 21} > v , ∀ i , j , i \neq j \qquad ( C0\_UL )$$

Moreover, the path gain PG_{21→20_j→20_i} described previously (equation E1) is then expressed for example as follows:

$${PG}_{21 \to 20 \_ j \to 20 \_ i} = {G}_{2 {0}_{j}} ( {λ}_{DL} ) {PG}_{21 \to 20 \_ j} ( {d}_{21 \to 20 \_ j} , {λ}_{DL} ) {PG}_{20 \_ j \to 20 \_ i} ( {d}_{20 \_ j \to 20 \_ i} , {λ}_{DL} )$$

with G_{20_j}(λ_{DL})=|gⱼ (Ψ_{a,21→20_j}, Ψ_{d,20_j→20_i, λ}_{DL})|² and λ_{DL} the downlink wavelength.

Considering the scenario of a downlink during which the intermediate RIS 20_j reflects, toward the main RIS 20_i, incident signals coming from the base station 21, the expression then becomes:

$${\vert {g}_{j} ( {Ψ}_{a , 21 \to 20 \_ j ,} , {Ψ}_{d , 20 \_ j \to 20 \_ i} , {λ}_{DL} ) \vert}^{2} = {N}_{j}^{2} {\vert \overline{{g}_{20 \_ j} ( {Ψ}_{a , 21 \to 20 \_ j} , {Ψ}_{d , 20 \_ j \to 20 \_ i} , {λ}_{DL} )} \vert}^{2}$$

Furthermore, the path gain PG_{20_i→20_j→21} of the path travelled by the uplink is expressed for example as follows:

$${PG}_{20 \_ i \to 20 \_ j \to 21} = {G}_{20 \_ j} ( {λ}_{UL} ) {PG}_{20 \_ i \to 20 \_ j} ( {d}_{20 \_ i \to 20 \_ j} , {λ}_{UL} ) {PG}_{20 \_ j \to 21} ( {d}_{20 \_ j \to 21} , {λ}_{UL} )$$

with G_{20_j}(λ_{UL})=∥gⱼ (Ψ_{a,21→20_j}, Ψ_{d,20_j→20_i}, λ_{UL})|² and λ_{UL} the uplink wavelength.

Considering the scenario of the uplink during which the main RIS 20_i reflects, toward the intermediate RIS 20_j, incident signals coming from the user terminal 23, the expression then becomes:

$${\vert {g}_{j} ( {Ψ}_{a , 20 \_ i \to 20 \_ j} , {Ψ}_{d , 20 \_ j \to 21} , {λ}_{UL} ) \vert}^{2} = {N}_{j}^{2} {\vert \overline{{g}_{20 \_ j} ( {Ψ}_{a , 20 \_ i \to 20 \_ j} , {Ψ}_{20 \_ j \to 21} , {λ}_{UL} )} \vert}^{2}$$

The disclosed technology has until now been described in the scenario in which the wireless communication system comprises only a single intermediate RIS 20_j. But the disclosed technology is no less applicable in the scenario in which the system comprises a plurality of intermediate RISs, for example two intermediate RIS 20_j=1 and 20_j=2. In this special case, in the scenario of a downlink, the positions are determined such that the signals emitted by the base station 21 are reflected by a first intermediate surface (for example 20_j=1) toward a second intermediate surface (for example 20_j=2), then such that the signals are reflected by this second intermediate surface toward the main surface 20_i to exchange data with user terminals 23 situated in the geographical area served by this main surface. Moreover, the positioning data are also determined such that the path gain PG_{21→20_j=1→20_j=2→20_i} of the path taken by said signals between the base station 21 and the user terminals 23 is greater than a predetermined threshold or maximized.

The disclosed technology has also been described in the scenario in which the RISs and the base station are all situated in one and the same plane defined by the ground (two dimensions). The disclosed technology is no less applicable in the base station 21 and the RISs of the set E are at different heights—i.e. the base station 21 and the RISs of the set E have variable elevations. In this special case, the constraints C2 to C4 are then expressed for example using spherical coordinates, and new relative constraints are added which have the aim of bounding the elevations of the base station 21 and of the RIS.

Finally, the disclosed technology has also been described in the scenario in which the optimization problem has the aim of determining relative distances as well as relative orientations between the entities of the wireless communication system. The disclosed technology is no less applicable in the scenario in which only distances are to be determined (the orientations then being for example fixed), but also in the scenario in which only orientations are to be determined (the distances then being for example fixed).

Although the present disclosure has been described with reference to one or more examples, workers skilled in the art will recognize that changes may be made in form and detail without departing from the scope of the disclosure and/or the appended claims.

What is claimed is:

1. A positioning method for positioning a set of reconfigurable intelligent surfaces associated with an access point of a telecommunications network, at least one reconfigurable intelligent surface of the set, called an “intermediate surface”, being positioned between the access point and at least one other reconfigurable intelligent surface of the set, called a “main surface”, configured to serve a given geographical area, the method being implemented by an electronic device and comprising:
determining positioning data of the intermediate and main surfaces such that: signals emitted by the access point are reflected by the intermediate surface toward the main surface to exchange data with at least one user terminal situated in the geographical area served by the main surface, a path gain of a path taken by said signals between the access point and said at least one user terminal is greater than a predetermined threshold or maximized, said path gain being a function parameterized by distances between the access point, the intermediate surface and/or the main surface, and/or by angles of said signals coming from the access point and reflected by the intermediate surface toward the main surface; and
processing said positioning data, so as to position said intermediate and main surfaces in accordance with said positioning data.

2. The positioning method according to claim 1, wherein the positioning data include a distance between the access point and the intermediate surface, a distance between the access point and the main surface, and/or between the intermediate surface and the main surface.

3. The positioning method according to claim 1, wherein the positioning data include an orientation of the intermediate surface and/or an orientation of the main surface.

4. The positioning method according to claim 1, wherein determining positioning data is implemented by considering that each of the surfaces of the subset is an “intermediate surface”, and by also considering that each of the surfaces of the subset is a “main surface”, each of said surfaces being associated with a given geographical area when it is a “main surface”, each of said surfaces being configured to reflect an incident signal toward the main surface when it is an “intermediate surface”.

5. The positioning method according to claim 1, wherein determining positioning data is moreover implemented such that the distance between the access point and the intermediate surface and/or the distance between the access point and the main surface and/or the distance between the main surface and the intermediate surface is bounded.

6. The positioning method according to claim 1, wherein determining positioning data is moreover implemented such that at least one component of an angle between the access point and the main surface, and/or an angle between the access point and the intermediate surface, and/or an angle between the main surface and the intermediate surface is bounded.

7. The positioning method according to claim 1, wherein the path gain of the path between the access point and said at least one user terminal corresponds to the combination of an antenna gain resulting from the reflection, by the intermediate surface, of signals emitted by the access point toward the main surface, of a path gain of a path taken by said signals between the access point and the intermediate surface, and of a path gain of a path taken by said signals between the intermediate surface and the main surface,
and wherein the antenna gain is a function parameterized by angles of incidence and reflection of the signals, the path gain of the path between the access point and the intermediate surface is a function parameterized by a distance between the access point and the intermediate surface, and the path gain of the path between the intermediate surface and the main surface is a function parameterized by a distance between the intermediate surface and the main surface.

8. The positioning method according to claim 1, wherein:
the access point is in a situation of direct line of sight with all or part of the intermediate surface, and/or
the main surface is in a situation of direct line of sight with all or part of the associated geographical area it serves, and/or
all or part of the main surface is in a situation of direct line of sight with all or part of the intermediate surface.

9. The method according to claim 1, wherein the method is implemented to position a plurality of intermediate surfaces between the access point and the main surface, and determining positioning data is implemented such that the intermediate surfaces are arranged along different respective directions with respect to the access point.

10. The method according to claim 1, wherein the method is implemented to position a plurality of intermediate surfaces between the access point and the main surface, and determining positioning data is implemented such that the intermediate surfaces are arranged along different respective directions with respect to the main surface.

11. An electronic managing device comprising:
a processor, said electronic managing device configured to:
determine positioning data of intermediate and main surfaces such that:
signals emitted by an access point are reflected by the intermediate surface toward the main surface to exchange data with at least one user terminal situated in a geographical area served by the main surface,
a path gain of a path taken by said signals between the access point and said at least one user terminal is greater than a predetermined threshold or maximized, said path gain being a function parameterized by distances between the access point, the intermediate surface and/or the main surface, and/or by angles of said signals coming from the access point and reflected by the intermediate surface toward the main surface; and
process said positioning data, so as to position said intermediate and main surfaces in accordance with said positioning data.

12. A method for positioning a set of reconfigurable intelligent surfaces associated with an access point of a telecommunications network, at least one reconfigurable intelligent surface of the set, called an “intermediate surface”, being positioned between the access point and at least one other reconfigurable intelligent surface of the set, called a “main surface”, configured to serve a given geographical area, the method being implemented by an electronic device and comprising:
determining positioning data of the intermediate and main surfaces such that:
signals emitted by at least one user terminal situated in the geographical area served by the main surface are reflected by the main surface toward the intermediate surface to exchange data with the access point,
a path gain of a path taken by said signals between said at least one user terminal and the access point is greater than a predetermined threshold or maximized, said path gain being a function parameterized by distances between the access point, the intermediate surface and/or the main surface, and/or by angles of said signals coming from the main surface and reflected by the intermediate surface toward the access point; and
processing said positioning data, so as to position said intermediate and main surfaces in accordance with said positioning data.

13. The positioning method according to claim 12, wherein the positioning data include a distance between the access point and the intermediate surface, a distance between the access point and the main surface, and/or between the intermediate surface and the main surface.

14. The positioning method according to claim 12, wherein the positioning data include an orientation of the intermediate surface and/or an orientation of the main surface.

15. The positioning method according to claim 12, wherein determining positioning data is implemented by considering that each of the surfaces of the subset is an “intermediate surface”, and by also considering that each of the surfaces of the subset is a “main surface”, each of said surfaces being associated with a given geographical area when it is a “main surface”, each of said surfaces being configured to reflect an incident signal toward the main surface when it is an “intermediate surface”.

16. The positioning method according to claim 12, wherein determining positioning data is moreover implemented such that the distance between the access point and the intermediate surface and/or the distance between the access point and the main surface and/or the distance between the main surface and the intermediate surface is bounded.

17. The positioning method according to claim 12, wherein determining positioning data is moreover implemented such that at least one component of an angle between the access point and the main surface, and/or an angle between the access point and the intermediate surface, and/or an angle between the main surface and the intermediate surface is bounded.

18. The positioning method according to claim 12, wherein the method is implemented to position a plurality of intermediate surfaces between the access point and the main surface, and determining positioning data is implemented such that the intermediate surfaces are arranged along different respective directions with respect to the access point.

19. The positioning method according to claim 12, wherein the method is implemented to position a plurality of intermediate surfaces between the access point and the main surface, and determining positioning data is implemented such that the intermediate surfaces are arranged along different respective directions with respect to the main surface.

20. An electronic managing device comprising:
a processor, said electronic managing device configured to:
determine positioning data of intermediate and main surfaces such that:
signals emitted by at least one user terminal situated in the geographical area served by the main surface are reflected by the main surface toward the intermediate surface to exchange data with an access point,
a path gain of a path taken by said signals between said at least one user terminal and the access point is greater than a predetermined threshold or maximized, said path gain being a function parameterized by distances between the access point, the intermediate surface and/or the main surface, and/or by angles of said signals coming from the main surface and reflected by the intermediate surface toward the access point; and
process said positioning data, so as to position said intermediate and main surfaces in accordance with said positioning data.
